(19) United States
(12) Patent Application Publication
(10) Pub. No.: US 2021/0172240 A1
(43) Pub. Date: Jun. 10, 2021

(54) THERMAL-BREAK ASSEMBLY

(71) Applicant: Jim KIRSCHNER, Bradford (CA)

(72) Inventor: Jim KIRSCHNER, Bradford (CA)

(21) Appl. No.: 17/078,232

(22) Filed: Oct. 23, 2020

Related U.S. Application Data
(60) Provisional application No. 62/944,146, filed on Dec. 5, 2019.

(51) Int. Cl. E06B 1/70; E04B 1/76; E04B 5/32; E02D 31/00

(52) U.S. Cl. CPC E06B 1/70; E04B 1/76; E06B 2001/707; E02D 31/00; E04B 2001/7679; E04B 5/32

(57) ABSTRACT

A thermal-break assembly including a thermal-insulation block configured to be installed between a first floor section and a second floor section. A weight-receiving device is configured to receive the thermal-insulation block. Spaced-apart reinforcing bars extend through, and beyond, the thermal-insulation block; this is done in such a way that the spaced-apart reinforcing bars, in use, extend into the first floor section and into the second floor section (once the thermal-insulation block is installed therebetween). The spaced-apart reinforcing bars are in intimate contact with the weight-receiving device.

### TECHNICAL FIELD

This document relates to the technical field of (and is not limited to) a thermal-break assembly to be installed in a building (and method therefor); more specifically, this document relates to the technical field of (and is not limited to) a thermal-break assembly to be installed between a first floor section and a second floor section (of a building) (and method therefor).

### BACKGROUND

FIG. 1 depicts a side view of the prior art. Referring to the embodiment as depicted in FIG. 1, a building 928 includes a first floor section 900 (an interior floor section, such as a garage portion of the building 928, etc.) configured to support a weight, such as the weight 904 (at least a part of the weight) of a vehicle 906. It will be appreciated that there may be costs associated with the operation of the building 928.

### SUMMARY

It will be appreciated that there exists a need to mitigate (at least in part) at least one problem associated with the existing buildings and/or existing thermal-break assemblies to be installed in buildings (also called the existing technology). After much study of, and experimentation with, the existing technology, an understanding (at least in part) of the problem and its solution have been identified (at least in part) and are articulated (at least in part) as follows:

Referring to the embodiment as depicted in FIG. 1, a building 928 includes a first floor section 900 (an interior floor section, such as a garage portion of the building 928, etc.) configured to support a weight, such as the weight 904 (or part thereof) of a vehicle 906. The first floor section 900 is positioned within the interior of the building 928. The building 928 includes a foundation footing 912 positioned in the soil 922 (below the working surface). The foundation footing 912 defines (provides) a keyway 913 facing upwardly. A foundation wall 914 is securely mounted or positioned on the foundation footing 912 in such a way that the foundation wall 914 extends vertically upwards toward a working surface located above the soil 922. On one side of the foundation footing 912 and the foundation wall 914, a foundation insulation layer 916 is positioned onto (in contact with) a surface of the foundation wall 914. The foundation insulation layer 916 is positioned to contact an interior compacted granular base 918. On another side (the opposite side) of the foundation footing 912 and the foundation wall 914, an exterior compacted granular base 920 is positioned. The exterior compacted granular base 920 is spaced apart from the interior compacted granular base 918. A notched wall 915 is securely mounted to a top portion of the foundation wall 914. The notched wall 915 extends vertically upward from the foundation wall 914 and above the working surface. A first thermal-energy flow 908 flows along a length of the first floor section 900 (that is positioned within the interior of the building 928) toward the notched wall 915, and then outwardly to the exterior of the building 928.

Referring to the embodiment as depicted in FIG. 1, there may be a significant amount of thermal energy lost to the exterior of the building 928, which may result in increased costs to operate the building 928. What may be needed is a way to reduce the cost of heating the interior of the building 928. More specifically, what may be needed is a way to reduce the cost of heating the interior of the building 928 by adding a thermal insulation component between a first floor section 900 and a second floor section 902 of the building 928 in such a way that the thermal insulation component is protected by a weight-receiving device 110 while the weight-receiving device 110 receives a weight (such as the weight 904, or part thereof, of the vehicle 906, etc.).

To mitigate, at least in part, at least one problem associated with the existing technology, there is provided (in accordance with a major aspect) an apparatus. The apparatus includes and is not limited to (comprises) a thermal-break assembly. The thermal-break assembly includes a thermal-insulation block configured to be installed between a first floor section and a second floor section of a building. A weight-receiving device is configured to receive the thermal-insulation block. Spaced-apart reinforcing bars extend through, and beyond, the thermal-insulation block in such a way that the spaced-apart reinforcing bars, in use, extend into the first floor section and into the second floor section (once the thermal-insulation block is installed therebetween). The spaced-apart reinforcing bars are in intimate contact with the weight-receiving device.

To mitigate, at least in part, at least one problem associated with the existing technology, there is provided (in accordance with a major aspect) an apparatus. The apparatus includes and is not limited to (comprises) a building having a first floor section and a second floor section of a building. A thermal-break assembly includes a thermal-insulation block configured to be installed between the first floor section and the second floor section. A weight-receiving device is configured to receive the thermal-insulation block. Spaced-apart reinforcing bars extend through, and beyond, the thermal-insulation block in such a way that the spaced-apart reinforcing bars, in use, extend into the first floor section and into the second floor section (once the thermal-insulation block is installed therebetween). The spaced-apart reinforcing bars are in intimate contact with the weight-receiving device.

To mitigate, at least in part, at least one problem associated with the existing technology, there is provided (in accordance with a major aspect) an apparatus. The apparatus includes and is not limited to (comprises) a thermal-break assembly. The thermal-break assembly includes a thermal-insulation block configured to be installed between a first floor section and a second floor section (of a building); this is done in such a way that the thermal-insulation block reduces the transfer of a first thermal-energy flow from the first floor section to the second floor section. A weight-receiving device is configured to receive a top block portion of the thermal-insulation block. Spaced-apart reinforcing bars extend through, and beyond, the thermal-insulation block in such a way that the spaced-apart reinforcing bars, in use, extend into the first floor section and into the second floor section (once the thermal-insulation block is installed therebetween). The spaced-apart reinforcing bars are in intimate contact with the weight-receiving device in such a way that the spaced-apart reinforcing bars (once the thermal-insulation block is installed) support a weight in cooperation with the first floor section and the second floor section (once the spaced-apart reinforcing bars: (A) receive the weight from the weight-receiving device, in which the weight is imposed on the weight-receiving device, and (B) transmit the weight, which was received from the weight-receiving device, to the first floor section and to the second floor section).

To mitigate, at least in part, at least one problem associated with the existing technology, there is provided (in accordance with a major aspect) an apparatus. The apparatus includes and is not limited to (comprises) a building having a first floor section and a second floor section. A thermal-break assembly includes a thermal-insulation block configured to be installed between the first floor section and the second floor section. A thermal-break assembly includes a thermal-insulation block configured to be installed between the first floor section and the second floor section in such a way that the thermal-insulation block reduces the transfer of a first thermal-energy flow from the first floor section to the second floor section. A weight-receiving device is configured to receive a top block portion of the thermal-insulation block. Spaced-apart reinforcing bars extend through, and beyond, the thermal-insulation block in such a way that the spaced-apart reinforcing bars, in use, extend into the first floor section and into the second floor section (once the thermal-insulation block is installed therebetween). The spaced-apart reinforcing bars are in intimate contact with the weight-receiving device in such a way that the spaced-apart reinforcing bars (once the thermal-insulation block is installed) support a weight in cooperation with the first floor section and the second floor section (once the spaced-apart reinforcing bars: (A) receive the weight from the weight-receiving device, in which the weight is imposed on the weight-receiving device, and (B) transmit the weight, which was received from the weight-receiving device, to the first floor section and to the second floor section).

To mitigate, at least in part, at least one problem associated with the existing technology, there is provided (in accordance with a major aspect) an apparatus. The apparatus includes and is not limited to (comprises) a thermal-break assembly. The thermal-break assembly includes a thermal-insulation block configured to be installed between a first floor section and a second floor section (of a building), in which the second floor section is spaced apart from the first floor section. The thermal-insulation block has a top surface configured to be positioned in a coplanar relationship with top floor surfaces of the first floor section and the second floor section (once the thermal-insulation block, in use, is installed between the first floor section and the second floor section). The thermal-insulation block has a first side surface and a second side surface spaced apart from, and coplanar with, the first side surface. The first side surface and the second side surface extend downwardly from the top surface. The first side surface and the second side surface are configured to respectively contact side surfaces of the first floor section and the second floor section (once the thermal-insulation block is installed between the first floor section and the second floor section). The thermal-insulation block has a thermal resistance configured to reduce transfer of a first thermal-energy flow from the first floor section to the second floor section (once the thermal-insulation block, in use, is installed between the first floor section and the second floor section). A weight-receiving device is configured to receive a top block portion of the thermal-insulation block. The weight-receiving device presents a top layer having a removable-protection layer installed thereon, and the removable-protection layer is configured to be removable (once the thermal-insulation block is installed between the first floor section and the second floor section). Spaced-apart reinforcing bars extend through the thermal-insulation block and beyond the first side surface and the second side surface. The spaced-apart reinforcing bars are configured to extend into the first floor section and into the second floor section (once the thermal-insulation block is installed between the first floor section and the second floor section). The spaced-apart reinforcing bars are positioned along a lower edge of, and in intimate contact with, the weight-receiving device (once the spaced-apart reinforcing bars extend through the thermal-insulation block and beyond the first side surface and the second side surface). The spaced-apart reinforcing bars are configured to receive a weight from the weight-receiving device, in which the weight is imposed on the weight-receiving device. The spaced-apart reinforcing bars are also configured to transmit the weight, which was received from the weight-receiving device, to the first floor section and to the second floor section. The spaced-apart reinforcing bars are configured to prevent inadvertent damage (buckling and/or deformation) of the weight-receiving device and the thermal-insulation block (once the weight-receiving device receives the weight, and the weight is transmitted to the first floor section and to the second floor section).

Other aspects are identified in the claims. Other aspects and features of the non-limiting embodiments may now become apparent to those skilled in the art upon review of the following detailed description of the non-limiting embodiments with the accompanying drawings. This Summary is provided to introduce concepts in simplified form that are further described below in the Detailed Description. This Summary is not intended to identify potentially key features or possible essential features of the disclosed subject matter, and is not intended to describe each disclosed embodiment or every implementation of the disclosed subject matter. Many other novel advantages, features, and relationships will become apparent as this description proceeds. The figures and the description that follow more particularly exemplify illustrative embodiments.

### BRIEF DESCRIPTION OF THE DRAWINGS

The non-limiting embodiments may be more fully appreciated by reference to the following detailed description of the non-limiting embodiments when taken in conjunction with the accompanying drawings, in which:

FIG. 1 depicts a side view of the prior art; and

FIG. 2 depicts a side view of an embodiment of a thermal-break assembly; and

FIG. 3 and FIG. 4 depict a perspective view (FIG. 3) and a top view (FIG. 4) of embodiments of the thermal-break assembly of FIG. 2; and

FIG. 5 and FIG. 6 depict a perspective view (FIG. 5) and a side view (FIG. 6) of embodiments of the thermal-break assembly of FIG. 2; and

FIG. 7, FIG. 8 and FIG. 9 depict a perspective view (FIG. 7), an end perspective view (FIG. 8) and a cross-sectional view (FIG. 9, which is taken along a cross-sectional line A-A of FIG. 7) of embodiments of the thermal-break assembly of FIG. 2; and

FIG. 10 and FIG. 11 depict cross-sectional views (which are taken along a cross-sectional line A-A of FIG. 7) of embodiments of the thermal-break assembly of FIG. 2.

The drawings are not necessarily to scale and may be illustrated by phantom lines, diagrammatic representations and fragmentary views. In certain instances, details unnecessary for an understanding of the embodiments (and/or details that render other details difficult to perceive) may have been omitted. Corresponding reference characters indicate corresponding components throughout the several figures of the drawings. Elements in the several figures are illustrated for simplicity and clarity and have not been drawn to scale. The dimensions of some of the elements in the figures may be emphasized relative to other elements for facilitating an understanding of the various disclosed embodiments. In addition, common, and well-understood, elements that are useful in commercially feasible embodiments are often not depicted to provide a less obstructed view of the embodiments of the present disclosure.

### LISTING OF REFERENCE NUMERALS USED IN THE DRAWINGS

thermal-break assembly 102

top surface 103

thermal-insulation block 104

first side surface 106

second side surface 108

weight-receiving device 110

U-shaped metal layer 111

top block portion 112

top layer 114

removable-protection layer 116

removal direction 117

spaced-apart reinforcing bars 118

water-impermeable layer 120

first floor section 900

second floor section 902

weight 904

vehicle 906

first thermal-energy flow 908

second thermal-energy flow 910

foundation footing 912

keyway 913

foundation wall 914

notched wall 915

foundation insulation layer 916

interior compacted granular base 918

exterior compacted granular base 920

soil 922

doorway 924

vertically-aligned reinforcing bars 926

building 928

### DETAILED DESCRIPTION OF THE NON-LIMITING EMBODIMENT(S)

The following detailed description is merely exemplary and is not intended to limit the described embodiments or the application and uses of the described embodiments. As used, the word “exemplary” or “illustrative” means “serving as an example, instance, or illustration.” Any implementation described as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure. The scope of the claim is defined by the claims (in which the claims may be amended during patent examination after the filing of this application). For the description, the terms “upper,” “lower,” “left,” “rear,” “right,” “front,” “vertical,” “horizontal,” and derivatives thereof shall relate to the examples as oriented in the drawings. There is no intention to be bound by any expressed or implied theory in the preceding Technical Field, Background, Summary or the following detailed description. It is also to be understood that the devices and processes illustrated in the attached drawings, and described in the following specification, are exemplary embodiments (examples), aspects and/or concepts defined in the appended claims. Hence, dimensions and other physical characteristics relating to the embodiments disclosed are not to be considered as limiting, unless the claims expressly state otherwise. It is understood that the phrase “at least one” is equivalent to “a”. The aspects (examples, alterations, modifications, options, variations, embodiments and any equivalent thereof) are described regarding the drawings. It should be understood that the invention is limited to the subject matter provided by the claims, and that the invention is not limited to the particular aspects depicted and described. It will be appreciated that the scope of the meaning of a device configured to be coupled to an item (that is, to be connected to, to interact with the item, etc.) is to be interpreted as the device being configured to be coupled to the item, either directly or indirectly. Therefore, “configured to” may include the meaning “either directly or indirectly” unless specifically stated otherwise.

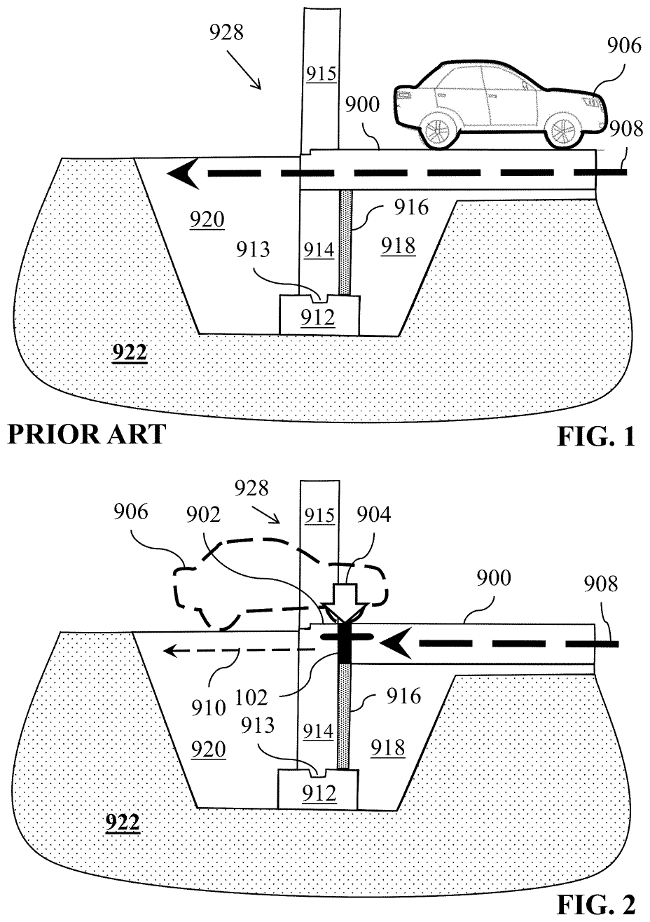

FIG. 1 depicts a side view of the prior art. Referring to the embodiment as depicted in FIG. 1, a building 928 includes a first floor section 900 (an interior floor section, such as a garage portion of the building 928, etc.) configured to support a weight, such as the weight 904 of a vehicle 906. It will be appreciated that there may be costs associated with the operation of the building 928. The first floor section 900 is positioned within the interior of the building 928. The building 928 includes a foundation footing 912 positioned in the soil 922 (below the working surface). The foundation footing 912 defines (provides) a keyway 913 facing upwardly. A foundation wall 914 is securely mounted or positioned on the foundation footing 912 in such a way that the foundation wall 914 extends vertically upwards toward a working surface located above the soil 922. On one side of the foundation footing 912 and the foundation wall 914, a foundation insulation layer 916 is positioned onto (in contact with) a surface of the foundation wall 914. The foundation insulation layer 916 is positioned to contact an interior compacted granular base 918. On another side (the opposite side) of the foundation footing 912 and the foundation wall 914, an exterior compacted granular base 920 is positioned. The exterior compacted granular base 920 is spaced apart from the interior compacted granular base 918. A notched wall 915 is securely mounted to a top portion of the foundation wall 914. The notched wall 915 extends vertically upward from the foundation wall 914 and above the working surface. A first thermal-energy flow 908 flows along a length of the first floor section 900 (that is positioned within the interior of the building 928) toward the notched wall 915, and then outwardly to the exterior of the building 928.

Referring to the embodiment as depicted in FIG. 1, there may be a significant amount of thermal energy lost to the exterior of the building 928, which may result in increased costs to operate the building 928. What may be needed is a way to reduce the cost of heating the interior of the building 928. More specifically, what may be needed is a way to reduce the cost of heating the interior of the building 928 by adding a thermal insulation component between a first floor section 900 and a second floor section 902 of the building 928.

FIG. 2 depicts a side view of an embodiment of a thermal-break assembly 102.

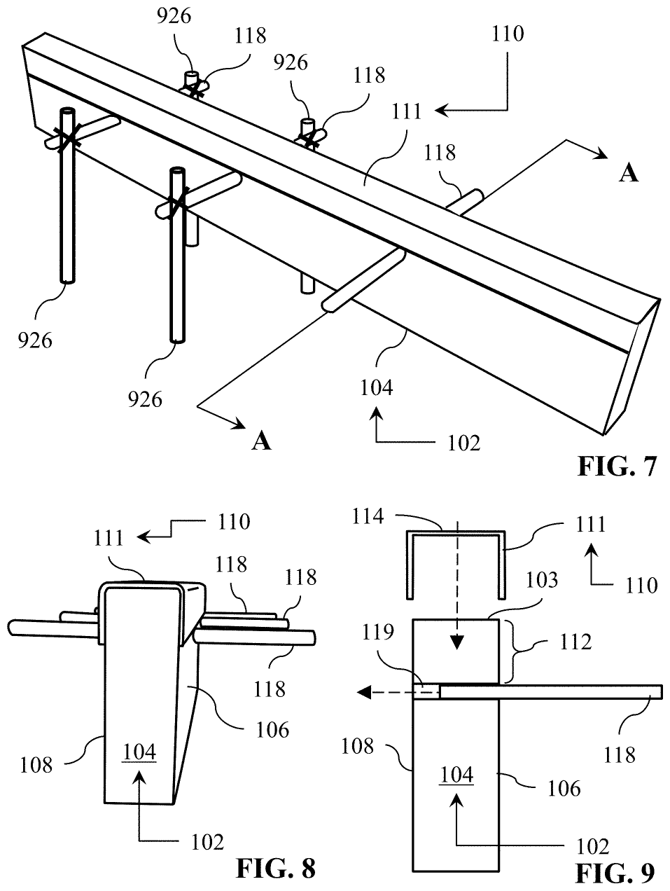

Referring to the embodiment as depicted in FIG. 2, the thermal-break assembly 102 is securely positioned between (and installed to) a first floor section 900 and a second floor section 902 of the building 928. For instance, the first floor section 900 is configured to support the weight 904 of a vehicle 906. For instance, the second floor section 902 is positioned on the top portion of the foundation wall 914. The thermal-insulation block 104 is configured to be installed between the first floor section 900 and the second floor section 902 of the building 928; this is done in such a way that the thermal-insulation block 104, in use, reduces the transfer of a first thermal-energy flow 908 from the first floor section 900 to the second floor section 902. As a result of utilizing the thermal-insulation block 104, a second thermal-energy flow 910 flows from the building 928 (from the first floor section 900 and the second floor section 902 of the building 928) toward the exterior compacted granular base 920 (that is, toward the exterior of the building 928). The magnitude of the first thermal-energy flow 908 is greater than the magnitude of the second thermal-energy flow 910. To further improve the longevity of the thermal-insulation block 104, the thermal-insulation block 104 may include a weight-receiving device 110 (as depicted in the embodiments of FIG. 7 to FIG. 11) configured to receive the weight 904 (such as, the weight of the vehicle 906, etc.). Embodiments of the thermal-insulation block 104 may include, for instance, a rigid foam insulation material, such as the MODEL SILVERBOARD GRAPHITE (TRADEMARK) rigid foam insulation product, the MODEL AMDRAIN (TRADEMARK) foundation insulation product, the MODEL ENVIROSHEET insulation board (or any combination thereof, or any equivalent thereof), all manufactured by AMVIC Building Systems headquartered in Ontario, Canada.

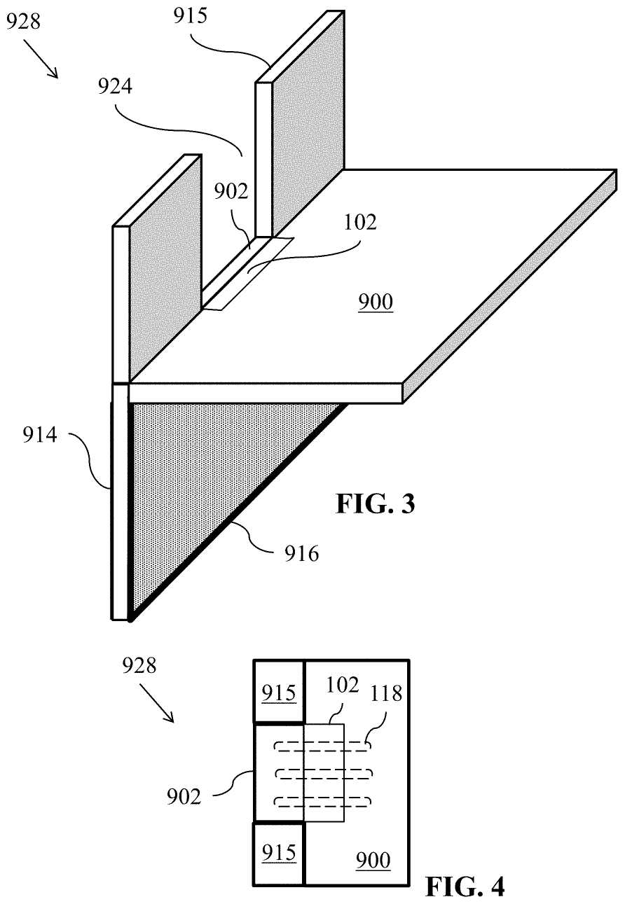

FIG. 3 and FIG. 4 depict a perspective view (FIG. 3) and a top view (FIG. 4) of embodiments of the thermal-break assembly 102 of FIG. 2.

Referring to the embodiment as depicted in FIG. 3, the thermal-break assembly 102 is positioned between (and is configured to be securely connected to) the first floor section 900 and the second floor section 902 of the building 928. The second floor section 902 is positioned over the foundation wall 914. The notched wall 915 is positioned proximate to (adjacent to) the second floor section 902. The foundation insulation layer 916 is positioned to cover, at least in part, the foundation wall 914. A doorway 924 is formed in the notched wall 915. The second floor section 902 forms a part of the doorway 924.

Referring to the embodiment as depicted in FIG. 4, the thermal-break assembly 102 includes outer side walls (the outer opposite side walls or spaced apart side walls). The thermal-break assembly 102 also includes spaced-apart reinforcing bars 118 that extend through the body of the thermal-break assembly 102, and also extend beyond the outer side walls (outer opposite side walls). The spaced-apart reinforcing bars 118, once installed, extend into the end sections of the first floor section 900 and the second floor section 902. In this manner, the weight 904 received by the thermal-break assembly 102 may be distributed to the first floor section 900 and the second floor section 902 of the building 928 via the spaced-apart reinforcing bars 118.

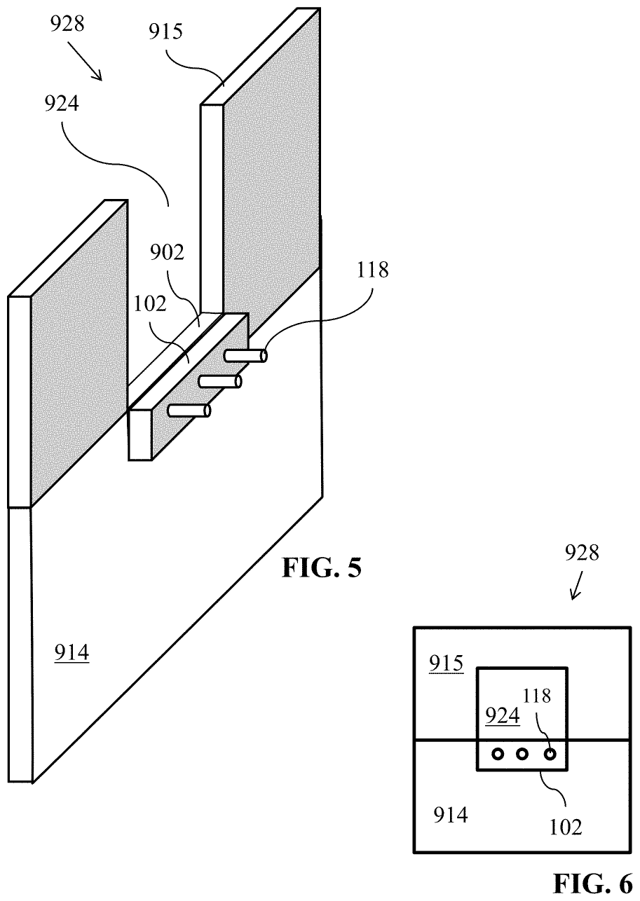

FIG. 5 and FIG. 6 depict a perspective view (FIG. 5) and a side view (FIG. 6) of embodiments of the thermal-break assembly 102 of FIG. 2.

Referring to the embodiments as depicted in FIG. 5 and FIG. 6, the thermal-break assembly 102 is exposed for improved viewing thereof. The thermal-break assembly 102 includes a set of spaced-apart reinforcing bars 118.

FIG. 7, FIG. 8 and FIG. 9 depict a perspective view (FIG. 7), an end perspective view (FIG. 8) and a cross-sectional view (FIG. 9, which is taken along a cross-sectional line A-A of FIG. 7) of embodiments of the thermal-break assembly 102 of FIG. 2.

Referring to the embodiment as depicted in FIG. 7, the thermal-insulation block 104 of the thermal-break assembly 102 includes an elongated body portion. The weight-receiving device 110 includes (for instance) a U-shaped metal layer 111. The spaced-apart reinforcing bars 118 extend outwardly from the opposite lateral sides of the thermal-insulation block 104. The vertically-aligned reinforcing bars 926 may be installed into the first floor section 900 (depicted in FIG. 2) and the exterior compacted granular base 920 (depicted in FIG. 2). The (spaced-apart) vertically-aligned reinforcing bars 926 are configured to be connectable to respective instances of the spaced-apart reinforcing bars 118.

Referring to the embodiment as depicted in FIG. 8, the thermal-insulation block 104 includes a first side surface 106 and a second side surface 108 spaced apart from each other. The weight-receiving device 110 includes (preferably) a U-shaped metal layer 111 positioned over at least a top portion of the thermal-insulation block 104. The spaced-apart reinforcing bars 118 extend through the body of the thermal-insulation block 104, and outwardly from the opposite sides of the thermal-insulation block 104.

Referring to the embodiment as depicted in FIG. 9, the thermal-insulation block 104 defines a channel 119 that extends between the first side surface 106 and the second side surface 108. The channel 119 is configured to receive (slidably receive) the spaced-apart reinforcing bars 118. The thermal-insulation block 104 includes (provides) a top surface 103. The weight-receiving device 110 includes the U-shaped metal layer 111. The U-shaped metal layer 111 is configured to be positioned over the top surface 103 of the thermal-break assembly 102. The opposite side walls of the U-shaped metal layer 111 extend along a top block portion 112 of the thermal-insulation block 104. More specifically, the opposite side walls of the U-shaped metal layer 111 extend along opposite sides of a top block portion 112 of the thermal-insulation block 104. A top layer 114 is positioned on the U-shaped metal layer 111.

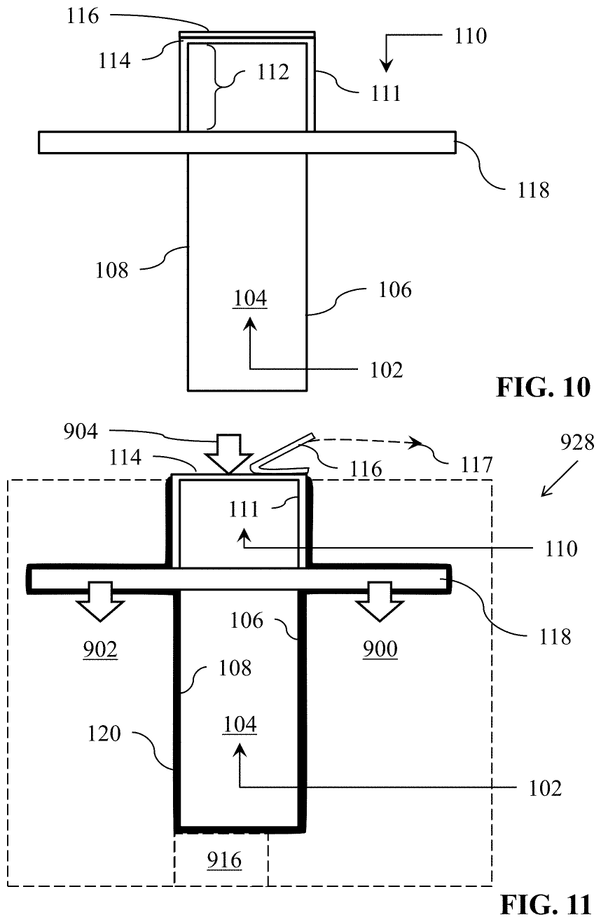

FIG. 10 and FIG. 11 depict cross-sectional views (which are taken along a cross-sectional line A-A of FIG. 7) of embodiments of the thermal-break assembly 102 of FIG. 2.

Referring to the embodiment as depicted in FIG. 10, a removable-protection layer 116 is positioned on the top layer 114 of the weight-receiving device 110 (such as, the U-shaped metal layer 111). The top block portion 112 of the thermal-insulation block 104 receives the U-shaped metal layer 111. The opposite sides of the U-shaped metal layer 111 contact at least a part of the first side surface 106 and the second side surface 108 (that is, contacts the top block portion 112 of the thermal-insulation block 104). The spaced-apart reinforcing bars 118 are in contact (intimate contact) with the lower portion (lower edge) of the weight-receiving device 110 (that is, the U-shaped metal layer 111) once the weight-receiving device 110 is installed to the thermal-insulation block 104. More specifically, the spaced-apart reinforcing bars 118 intimately contact (contact) the lower portion (lower edge) of the U-shaped metal layer 111. In this manner, the weight 904 to be received by the weight-receiving device 110 may be transferred to the spaced-apart reinforcing bars 118 (and then the weight 904 may be transferred from the spaced-apart reinforcing bars 118 over to the first floor section 900 and the second floor section 902, as depicted in FIG. 11).

Referring to the embodiment as depicted in FIG. 11, an apparatus includes and is not limited to (comprises) a thermal-break assembly 102. The thermal-break assembly 102 includes and is not limited to (comprises) a synergistic combination of a thermal-insulation block 104, a weight-receiving device 110, and spaced-apart reinforcing bars 118. The thermal-insulation block 104 is configured to be installed between a first floor section 900 and a second floor section 902 of a building 928. The weight-receiving device 110 is configured to receive the thermal-insulation block 104. The spaced-apart reinforcing bars 118 extend through, and beyond, the thermal-insulation block 104; this is done in such a way that the spaced-apart reinforcing bars 118, in use, extend into the first floor section 900 and into the second floor section 902 (once the thermal-insulation block 104 is installed therebetween). The spaced-apart reinforcing bars 118 are in intimate contact with the weight-receiving device 110 (that is, once the spaced-apart reinforcing bars 118 extend through, and beyond, the thermal-insulation block 104, and the weight-receiving device 110 receives the thermal-insulation block 104). In accordance with a preferred embodiment, the thermal-break assembly 102 includes outer opposite spaced-apart side walls.

Referring to the embodiment as depicted in FIG. 11, an apparatus includes and is not limited to (comprises) a building 928 having a first floor section 900 and a second floor section 902. A thermal-break assembly 102 includes a thermal-insulation block 104 configured to be installed between the first floor section 900 and the second floor section 902. A weight-receiving device 110 is configured to receive the thermal-insulation block 104. Spaced-apart reinforcing bars 118 extend through, and beyond, the thermal-insulation block 104 in such a way that the spaced-apart reinforcing bars 118, in use, extend into the first floor section 900 and into the second floor section 902 (once the thermal-insulation block 104 is installed therebetween). The spaced-apart reinforcing bars 118 are in intimate contact with the weight-receiving device 110.

Referring to the embodiment as depicted in FIG. 11, an apparatus includes and is not limited to (comprises) a thermal-break assembly 102. The thermal-break assembly 102 includes and is not limited to (comprises) a synergistic combination of a thermal-insulation block 104, a weight-receiving device 110, and spaced-apart reinforcing bars 118.

Referring to the embodiment as depicted in FIG. 11, the thermal-insulation block 104 is configured to be installed between a first floor section 900 and a second floor section 902 of a building 928; this is done in such a way that the thermal-insulation block 104 reduces the transfer of a first thermal-energy flow 908 from the first floor section 900 to the second floor section 902.

Referring to the embodiment as depicted in FIG. 11, the weight-receiving device 110 is configured to receive a top block portion 112 of the thermal-insulation block 104.

Referring to the embodiment as depicted in FIG. 11, the spaced-apart reinforcing bars 118 extend through, and beyond, the thermal-insulation block 104; this is done in such a way that the spaced-apart reinforcing bars 118, in use, extend into the first floor section 900 and into the second floor section 902 (once the thermal-insulation block 104 is installed therebetween).

Referring to the embodiment as depicted in FIG. 11, the spaced-apart reinforcing bars 118 are in intimate contact with the weight-receiving device 110; this is done in such a way that the spaced-apart reinforcing bars 118 (once the thermal-insulation block 104 is installed) support a weight 904 in cooperation with the first floor section 900 and the second floor section 902 (preferably, once the spaced-apart reinforcing bars 118: (A) receive the weight 904 from the weight-receiving device 110, in which the weight 904 is imposed on the weight-receiving device 110, and (B) transmit the weight 904, which was received from the weight-receiving device 110, to the first floor section 900 and to the second floor section 902.

Referring to the embodiment as depicted in FIG. 11, the foundation insulation layer 916 is positioned below the thermal-insulation block 104. More specifically, the foundation insulation layer 916 is positioned below the thermal-insulation block 104 once the thermal-insulation block 104 is installed between the first floor section 900 and the second floor section 902 of a building 928. The weight-receiving device 110 and the spaced-apart reinforcing bars 118 cooperate to prevent inadvertent physical damage to the foundation insulation layer 916 by transference of the weight 904 from the weight-receiving device 110 to the first floor section 900 and the second floor section 902 via the spaced-apart reinforcing bars 118.

Referring to the embodiment as depicted in FIG. 11, the weight-receiving device 110 includes a U-shaped metal layer 111 configured to receive a top block portion 112 of the thermal-insulation block 104.

Referring to the embodiment as depicted in FIG. 11, the weight-receiving device 110 presents a top layer 114 having a removable-protection layer 116 installed thereon. The removable-protection layer 116 is configured to be removable (by a user, preferably once the thermal-insulation block 104 is installed between the first floor section 900 and the second floor section 902).

Referring to the embodiment as depicted in FIG. 11, the thermal-insulation block 104 is water impermeable.

Referring to the embodiment as depicted in FIG. 11, the apparatus further includes (and is not limited to) a water-impermeable layer 120 (coating) covering portions of the spaced-apart reinforcing bars 118 that extend outwardly from the thermal-insulation block 104. Preferably, the water-impermeable layer 120 also covers, at least in part, a first side surface 106 and a second side surface 108 of the thermal-insulation block 104 from which the spaced-apart reinforcing bars 118 extend outwardly from the thermal-insulation block 104. The water-impermeable layer 120 may include, for instance, the LIQUID RUBBER WATERPROOF SEALANT/COATING product manufactured or supplied by LIQUIDRUBBER Company located in Ontario Canada (or any equivalent thereof).

Referring to the embodiment as depicted in FIG. 11, an apparatus includes and is not limited to (comprises) a thermal-break assembly 102. The thermal-break assembly 102 includes and is not limited to (comprises) a synergistic combination of a thermal-insulation block 104, a weight-receiving device 110, and spaced-apart reinforcing bars 118.

Referring to the embodiment as depicted in FIG. 11, the thermal-insulation block 104 is configured to be installed between a first floor section 900 and a second floor section 902 of a building 928 (the second floor section 902 is spaced apart from the first floor section 900). The thermal-insulation block 104 has a top surface 103 configured to be in positioned in a coplanar relationship with top floor surfaces of the first floor section 900 and the second floor section 902 (that is, once the thermal-insulation block 104, in use, is installed between the first floor section 900 and the second floor section 902). The thermal-insulation block 104 has a first side surface 106 and a second side surface 108 spaced apart from, and coplanar with, the first side surface 106. The first side surface 106 and the second side surface 108 extend (preferably vertically) downwardly from the top surface 103 (preferably, once the thermal-insulation block 104 is installed). The first side surface 106 and the second side surface 108 are configured to respectively contact side surfaces of the first floor section 900 and the second floor section 902 (preferably, once the thermal-insulation block 104 is installed between the first floor section 900 and the second floor section 902). The thermal-insulation block 104 has a thermal resistance configured to reduce transfer of a first thermal-energy flow 908 from the first floor section 900 to the second floor section 902 (preferably, once the thermal-insulation block 104, in use, is installed between the first floor section 900 and the second floor section 902).

Referring to the embodiment as depicted in FIG. 11, the weight-receiving device 110 is configured to receive a top block portion 112 of the thermal-insulation block 104. The weight-receiving device 110 presents (provides) a top layer 114 having a removable-protection layer 116 installed thereon. The removable-protection layer 116 is configured to be removable (by a user) (preferably, once the thermal-insulation block 104 is installed between the first floor section 900 and the second floor section 902).

Referring to the embodiment as depicted in FIG. 11, the spaced-apart reinforcing bars 118 extend through the thermal-insulation block 104 and beyond the first side surface 106 and the second side surface 108. The spaced-apart reinforcing bars 118 are configured to extend into the first floor section 900 and into the second floor section 902 (preferably, once the thermal-insulation block 104 is installed between the first floor section 900 and the second floor section 902). The spaced-apart reinforcing bars 118 are positioned along a lower edge of, and in intimate contact with, the weight-receiving device 110 (preferably, once the spaced-apart reinforcing bars 118 extend through the thermal-insulation block 104 and beyond the first side surface 106 and the second side surface 108). The spaced-apart reinforcing bars 118 are configured to receive a weight 904 from the weight-receiving device 110, in which the weight 904 is imposed on the weight-receiving device 110. The spaced-apart reinforcing bars 118 are also configured to transmit the weight 904, which was received from the weight-receiving device 110, to the first floor section 900 and to the second floor section 902. The spaced-apart reinforcing bars 118 are also configured to prevent inadvertent damage (buckling and/or deformation) of the weight-receiving device 110 and the thermal-insulation block 104 (preferably, once the weight-receiving device 110 receives the weight 904, and the weight 904 is transmitted to the first floor section 900 and to the second floor section 902).

Referring to the embodiment as depicted in FIG. 11, the weight-receiving device 110 includes a U-shaped metal layer 111 configured to receive a top block portion 112 of the thermal-insulation block 104.

Referring to the embodiment as depicted in FIG. 11, the thermal-insulation block 104 is water impermeable.

Referring to the embodiment as depicted in FIG. 11, the apparatus further includes (and is not limited to) a water-impermeable layer 120 (coating) covering portions of the spaced-apart reinforcing bars 118 that extend outwardly from the thermal-insulation block 104. Preferably, the water-impermeable layer 120 also covers portions of the first side surface 106 and the second side surface 108 of the thermal-insulation block 104 from which the spaced-apart reinforcing bars 118 extend outwardly from the thermal-insulation block 104. Preferably, the water-impermeable layer 120 also covers opposite lateral vertical sides of the weight-receiving device 110.

In view of the foregoing, in accordance with an embodiment, a purpose of the apparatus is to provide an extra layer of insulation to a concrete floor, whether the apparatus is configured for installation in a residential dwelling, garage, commercial, institutional, storage, warehouse building, etc. Basically, any building that has a poured concrete floor, where heating and/or cooling may be present. As of now, new construction of any type of building types listed above may be required to provide a 3.5 inch insulation layer (such as EPS (Expanded Polystyrene) rigid insulation separation layer, and any equivalent thereof) between an exterior below grade foundation wall and an interior backfill under the interior slab, that extends down to the poured concrete footing and extends up to the bottom side of the poured concrete slab. Expanded polystyrene (EPS) foam is a closed-cell insulation that's manufactured by expanding a polystyrene polymer; the appearance is typically a white foam plastic insulation material (the likes of which can be found as merchandise packaging). Extruded polystyrene (XPS) foam is a rigid insulation that's also formed with polystyrene polymer, but manufactured using an extrusion process, and is often manufactured with a distinctive color to identify product brand. The insulation layer provides an insulating barrier between the outside of a building below grade and the area under a concrete slab, thus helping prevent cold (that is, the absence of heat energy) from having a direct channel from the outside of the building to the inside of the building. The insulation layer helps to reduce energy loss. Concrete has a very poor thermal insulating value, but is a very good conductor of thermal energy (heat and cold), thus the need to have a separating thermal barrier between interior and exterior (of the building) where a below grade concrete wall is involved.

Unfortunately, at each, and every doorway (whether the doorway is or includes an entry door, a sliding door in a walkout basement door, a roll-up door, or any kind of door that sits upon a concrete floor), the concrete slab under the doorway extends outside at least flush and in some cases up to eight (8) inches past the outside edge of the door in a continuous pour of concrete up to six (6) inches in depth, unimpeded directly under the door, thus providing a direct conduit for energy transfer under the doorway. For example, cold may penetrate in the winter season, and heat may enter the floor in the summer season, etc.

In the context of building and construction, the R-value is a measure of how well a two-dimensional barrier resists the conductive flow of heat. Even for the case where the best “R” value doors are installed (that money can buy), up until now there was no way to insulate directly under the doorways. With an embodiment of the apparatus, one may now add, for instance, an R-16 value insulating protection layer directly under the doorway (any type of doorway). Particularly valuable under a garage door or a warehouse door where energy transfer may be a major concern, because an embodiment of the apparatus is configured to be installed flush with the floor, and has a protective metal exposed top section which can be driven on without damaging the apparatus, the embodiment of the apparatus provides a permanent energy saving solution under the doorway, thus potentially creating relatively larger cost savings in heating and/or cooling costs. In the past, we were all taught to close a door to keep the cold out. Now, with an embodiment of the apparatus, you may close the door on the floor as well, and the user may think “Thermal Floor Door”. Close the door on the floor, permanently. An embodiment of the apparatus may be suited for new construction, and may also be retrofitted into existing buildings.

The following is offered as further description of the embodiments, in which any one or more of any technical feature (described in the detailed description, the summary and the claims) may be combinable with any other one or more of any technical feature (described in the detailed description, the summary and the claims). It is understood that each claim in the claims section is an open ended claim unless stated otherwise. Unless otherwise specified, relational terms used in these specifications should be construed to include certain tolerances that the person skilled in the art would recognize as providing equivalent functionality. By way of example, the term perpendicular is not necessarily limited to 90.0 degrees, and may include a variation thereof that the person skilled in the art would recognize as providing equivalent functionality for the purposes described for the relevant member or element. Terms such as “about” and “substantially”, in the context of configuration, relate generally to disposition, location, or configuration that are either exact or sufficiently close to the location, disposition, or configuration of the relevant element to preserve operability of the element within the invention which does not materially modify the invention. Similarly, unless specifically made clear from its context, numerical values should be construed to include certain tolerances that the person skilled in the art would recognize as having negligible importance as they do not materially change the operability of the invention. It will be appreciated that the description and/or drawings identify and describe embodiments of the apparatus (either explicitly or inherently). The apparatus may include any suitable combination and/or permutation of the technical features as identified in the detailed description, as may be required and/or desired to suit a particular technical purpose and/or technical function. It will be appreciated that, where possible and suitable, any one or more of the technical features of the apparatus may be combined with any other one or more of the technical features of the apparatus (in any combination and/or permutation). It will be appreciated that persons skilled in the art would know that the technical features of each embodiment may be deployed (where possible) in other embodiments even if not expressly stated as such above. It will be appreciated that persons skilled in the art would know that other options would be possible for the configuration of the components of the apparatus to adjust to manufacturing requirements and still remain within the scope as described in at least one or more of the claims. This written description provides embodiments, including the best mode, and also enables the person skilled in the art to make and use the embodiments. The patentable scope may be defined by the claims. The written description and/or drawings may help to understand the scope of the claims. It is believed that all the crucial aspects of the disclosed subject matter have been provided in this document. It is understood, for this document, that the word “includes” is equivalent to the word “comprising” in that both words are used to signify an open-ended listing of assemblies, components, parts, etc. The term “comprising”, which is synonymous with the terms “including,” “containing,” or “characterized by,” is inclusive or open-ended and does not exclude additional, unrecited elements or method steps. Comprising (comprised of) is an “open” phrase and allows coverage of technologies that employ additional, unrecited elements. When used in a claim, the word “comprising” is the transitory verb (transitional term) that separates the preamble of the claim from the technical features of the invention. The foregoing has outlined the non-limiting embodiments (examples). The description is made for particular non-limiting embodiments (examples). It is understood that the non-limiting embodiments are merely illustrative as examples.

What is claimed is:

1. An apparatus, comprising:
a thermal-break assembly, including:
a thermal-insulation block configured to be installed between a first floor section and a second floor section of a building; and
a weight-receiving device configured to receive the thermal-insulation block; and
spaced-apart reinforcing bars extending through, and beyond, the thermal-insulation block in such a way that the spaced-apart reinforcing bars, in use, extend into the first floor section and into the second floor section once the thermal-insulation block is installed therebetween; and
the spaced-apart reinforcing bars being in intimate contact with the weight-receiving device.

2. An apparatus, comprising:
a thermal-break assembly, including:
a thermal-insulation block configured to be installed between a first floor section and a second floor section of a building in such a way that the thermal-insulation block reduces transfer of a first thermal-energy flow from the first floor section to the second floor section; and
a weight-receiving device configured to receive a top block portion of the thermal-insulation block; and
spaced-apart reinforcing bars extending through, and beyond, the thermal-insulation block in such a way that the spaced-apart reinforcing bars, in use, extend into the first floor section and into the second floor section once the thermal-insulation block is installed therebetween; and
the spaced-apart reinforcing bars being in intimate contact with the weight-receiving device in such a way that the spaced-apart reinforcing bars, once the thermal-insulation block is installed, support a weight in cooperation with the first floor section and the second floor section once the spaced-apart reinforcing bars:
receive the weight from the weight-receiving device, in which the weight is imposed on the weight-receiving device; and
transmit the weight, which was received from the weight-receiving device, to the first floor section and to the second floor section.

3. The apparatus of claim 2, wherein:
the weight-receiving device includes a U-shaped metal layer configured to receive the top block portion of the thermal-insulation block.

4. The apparatus of claim 3, wherein:
the weight-receiving device presents a top layer having a removable-protection layer installed thereon; and
the removable-protection layer is configured to be removable.

5. The apparatus of claim 3, wherein:
the thermal-insulation block is water impermeable.

6. The apparatus of claim 3, further comprising:
a water-impermeable layer covering portions of the spaced-apart reinforcing bars that extend outwardly from the thermal-insulation block; and
the water-impermeable layer also covering, at least in part, a first side surface and a second side surface of the thermal-insulation block from which the spaced-apart reinforcing bars extend outwardly from the thermal-insulation block.

7. An apparatus, comprising:
a building having a first floor section and a second floor section spaced apart from the first floor section; and
a thermal-break assembly, including:
a thermal-insulation block configured to be installed between the first floor section and the second floor section, in which the second floor section is spaced apart from the first floor section; and
the thermal-insulation block having a top surface configured to be positioned in a coplanar relationship with top floor surfaces of the first floor section and the second floor section once the thermal-insulation block, in use, is installed between the first floor section and the second floor section; and
the thermal-insulation block having a first side surface and a second side surface spaced apart from, and coplanar with, the first side surface; and
the first side surface and the second side surface extending downwardly from the top surface; and
the first side surface and the second side surface configured to respectively contact side surfaces of the first floor section and the second floor section once the thermal-insulation block is installed between the first floor section and the second floor section; and
the thermal-insulation block having a thermal resistance configured to reduce transfer of a first thermal-energy flow from the first floor section to the second floor section once the thermal-insulation block, in use, is installed between the first floor section and the second floor section; and
a weight-receiving device configured to receive a top block portion of the thermal-insulation block; and
the weight-receiving device presenting a top layer having a removable-protection layer installed thereon, and the removable-protection layer configured to be removable once the thermal-insulation block is installed between the first floor section and the second floor section; and
spaced-apart reinforcing bars extending through the thermal-insulation block and beyond the first side surface and the second side surface; and
the spaced-apart reinforcing bars configured to extend into the first floor section and into the second floor section once the thermal-insulation block is installed between the first floor section and the second floor section; and
the spaced-apart reinforcing bars being positioned along a lower edge of, and in intimate contact with, the weight-receiving device once the spaced-apart reinforcing bars extend through the thermal-insulation block and beyond the first side surface and the second side surface; and
the spaced-apart reinforcing bars configured to:
receive a weight from the weight-receiving device, in which the weight is imposed on the weight-receiving device; and
transmit the weight, which was received from the weight-receiving device, to the first floor section and to the second floor section; and
prevent inadvertent damage of the weight-receiving device and the thermal-insulation block once the weight-receiving device receives the weight, and the weight is transmitted to the first floor section and to the second floor section.

8. The apparatus of claim 7, wherein:
the weight-receiving device includes a U-shaped metal layer configured to receive the top block portion of the thermal-insulation block.

9. The apparatus of claim 7, wherein:
the thermal-insulation block is water impermeable.

10. The apparatus of claim 7, further comprising:
a water-impermeable layer covering portions of the spaced-apart reinforcing bars that extend outwardly from the thermal-insulation block; and
the water-impermeable layer also covering portions of the first side surface and the second side surface of the thermal-insulation block from which the spaced-apart reinforcing bars extend outwardly from the thermal-insulation block; and
the water-impermeable layer also covering opposite lateral vertical sides of the weight-receiving device.

11. The apparatus of claim 7, wherein:
the second floor section is positioned on a top portion of a foundation wall of the building.

12. The apparatus of claim 7, wherein:
a notched wall is positioned proximate to the second floor section; and
a doorway is formed in the notched wall; and
the second floor section forms a part of the doorway.

13. The apparatus of claim 7, wherein:
the thermal-break assembly includes outer opposite spaced-apart side walls; and
the spaced-apart reinforcing bars extend through a body of the thermal-break assembly, and also extend beyond the outer opposite spaced-apart side walls; and
the spaced-apart reinforcing bars, once installed, extend into end sections of the first floor section and the second floor section; and
the weight, once received by the thermal-break assembly, is distributed to the first floor section and the second floor section of the building via the spaced-apart reinforcing bars.

14. The apparatus of claim 7, wherein:
the spaced-apart reinforcing bars extend through a body of the thermal-insulation block, and outwardly from opposite sides of the thermal-insulation block.

15. The apparatus of claim 14, wherein:
the weight-receiving device includes a U-shaped metal layer.

16. The apparatus of claim 15, wherein:
the U-shaped metal layer is configured to be positioned over the top surface of the thermal-break assembly; and
opposite side walls of the U-shaped metal layer extend along opposite sides of the top block portion of the thermal-insulation block.

17. The apparatus of claim 16, wherein:
the U-shaped metal layer includes the top layer.

18. The apparatus of claim 16, wherein:
the removable-protection layer is positioned on the top layer of the U-shaped metal layer.

19. The apparatus of claim 16, wherein:
the spaced-apart reinforcing bars intimately contact a lower edge of the U-shaped metal layer; and
the weight, to be received by the U-shaped metal layer, is transferred to the spaced-apart reinforcing bars, and is then transferred from the spaced-apart reinforcing bars over to the first floor section and the second floor section.

20. The apparatus of claim 16, wherein:
a foundation insulation layer is positioned below the thermal-insulation block once the thermal-insulation block is installed between the first floor section and the second floor section of a building; and
the weight-receiving device and the spaced-apart reinforcing bars cooperate to prevent inadvertent physical damage to the foundation insulation layer by transference of the weight from the weight-receiving device to the first floor section and the second floor section via the spaced-apart reinforcing bars.
